(19) United States
(12) Patent Application Publication
(10) Pub. No.: US 2007/0171488 A1
(43) Pub. Date: Jul. 26, 2007

(54) Image scanning device and method

(75) Inventors: Yen-Cheng Chen, Hsinchu (TW); Yu-Lang Wang, Hsinchu (TW)

Correspondence Address: CHARLES E. BAXLEY, ESQ., 90 JOHN STREET, THIRD FLOOR, NEW YORK, NY, 10038, US

(73) Assignee: Avision Inc.

(21) Appl. No.: 11/698,732

(22) Filed: Jan. 26, 2007

(30) Foreign Application Priority Data
Jan. 26, 2006 (TW) 095102996

(51) Int. Cl. H04N 1/04

(52) U.S. Cl. 358/498; 382/108

(57) ABSTRACT

The invention provides an image scanning device and an image scanning method. The image scanning device has an automatic sheet feeding function and is equipped with a detector for detecting a thickness of a sheet. Also, the thickness may serve as a scanning parameter, according to which a scanning speed is adjusted so that the quality of a scanned image can be maintained.

### BACKGROUND OF THE INVENTION

1. Field of the Invention

The invention relates in general to a scanning device and a scanning method, wherein the scanning device has an automatic sheet feeding function and may be, for example, a combination of a flatbed scanner and an automatic sheet feeder, a sheet-fed scanner, a multi-function peripheral, a copier, or the like. The scanning method determines a scanning speed according to a thickness of a sheet.

2. Prior Art

When a typical scanner is scanning an image, the scanner usually employs different scanning speeds for generating images of different resolutions. For example, when a low-resolution image is required to be generated, a high scanning speed may be used because the data quantity of the image is relative small; and when a high-resolution image is required to be generated, a low scanning speed is used because the data quantity of the image is relative large. In addition, in different scanning modes of the scanner, such as black-and-white, gray-scale and color scanning modes, the scanner would employs different scanning speeds because different resolutions and data quantity of the images are required.

The scanning speed of the conventional sheet-fed scanner is often influenced by the image resolution and the scanning mode. Thus, the relationship between the scanning mode, the image resolution, and the scanning speed is usually specified in the specification of the scanner. The scanning speed is usually represented by pages per minute (PPM). In practice, however, the quality of the image generated greatly relates to the scanning speed due to not only the selection of the scanning mode or the image resolution but also the smoothness of the sheet-feeding operation. The resistance induced by the moving sheet often affects the sheet-feeding operation, and the thickness of the sheet is an important factor of deciding the degree of the resistance and thus the image quality. Thus, a sheet feeding mechanism of the scanner has to provide a greater torque for transporting a thicker sheet at a lower speed so that the sheet may be transported smoothly, while a thinner sheet can be transported at a higher speed because the torque required does not need to be too large. However, the prior art does not particularly consider this factor.

### SUMMARY OF THE INVENTION

It is therefore an object of the invention to provide a scanning device capable of detecting a thickness of a sheet simply and rapidly.

Another object of the invention is to provide a scanning method capable of ensuring the consistency of the image quality by automatically adjusting a scanning speed according to the thickness of the sheet.

The invention achieves the above-identified objects by providing a scanning device having an automatic sheet feeding function. The scanning device also has a detector for detecting a thickness of a sheet in a simple and rapid manner. The detector may be an ultrasonic or infrared transceiver. The thickness of the sheet can be determined by the comparison of the transmissive or reflected acoustic/light wave or the phase analysis of the transmissive or reflected acoustic/light wave.

The invention also achieves the above-identified object by providing a scanning method of determining a scanning speed according to a thickness of a sheet. When the sheet is thicker, the scanning speed is set to be slower or the torque of the sheet-feeding mechanism is set to be larger. When the sheet is thinner, the scanning speed is higher or the torque is smaller. The method of adjusting the scanning speed and the torque can be typically achieved by controlling the output of a power source, such as the output power or the rotational speed of the motor.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a scanning device according to a first embodiment of the invention;

FIG. 2 is a schematic illustration showing a scanning device according to a second embodiment of the invention;

FIG. 3 is a schematic illustration showing a state, in which a transmissive signal detector is used, according to the invention;

FIG. 4 is a schematic illustration showing another state, in which a reflective signal detector is used, according to the invention;

FIG. 5 is a block diagram showing a scanning method according to a third embodiment of the invention;

FIG. 6 is a block diagram showing a scanning method according to a fourth embodiment of the invention; and

FIG. 7 is a block diagram showing a scanning method according to a fifth embodiment of the invention.

### DETAILED DESCRIPTION OF THE PREFERRED EMBODIMENT OF THE INVENTION

The scanning device of the invention has an automatic sheet feeding function, and may include a combination of a flatbed scanner and an automatic sheet feeder, a sheet-fed scanner, a multi-function peripheral, or a copier.

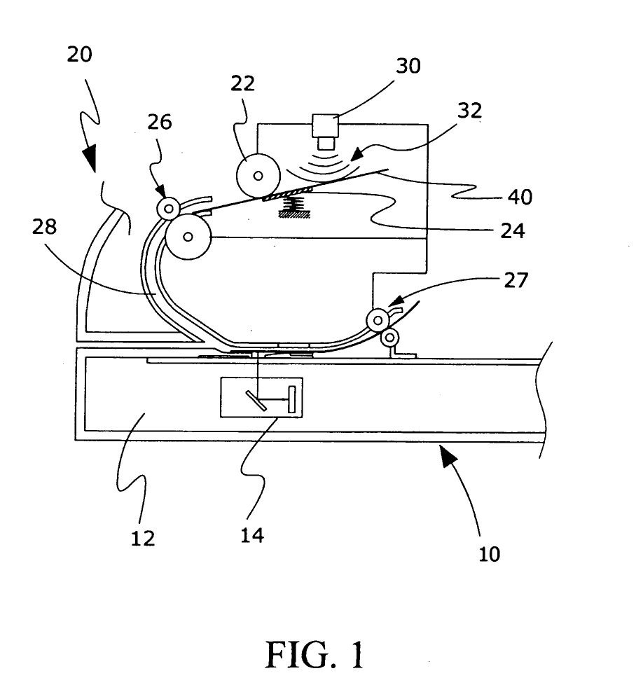

Referring to FIG. 1, the scanning device is composed of a flatbed scanner 10 and an automatic sheet feeder 20. The flatbed scanner 10 has a body 12 in which a scanning module 14 for scanning a sheet 40 is disposed. The scanning module 14 includes a light source, a plurality of reflecting mirrors, a lens and an image sensor.

The automatic sheet feeder 20, disposed on the flatbed scanner 10 and connected with the body 12, includes a feeding roller 22, a friction pad 24, roller sets 26 and 27 and a passageway 28. The friction pad 24 faces the feeding roller 22, and the roller sets 26 and 27 are installed on the passageway 28.

It is appreciated that the automatic sheet feeder 20 further includes a detector 30 for outputting a detecting signal 32 to the sheet 40. The detector 30 may be an ultrasonic transceiver or an infrared transceiver, where the detecting signal 32 is an ultrasonic waves or infrared light.

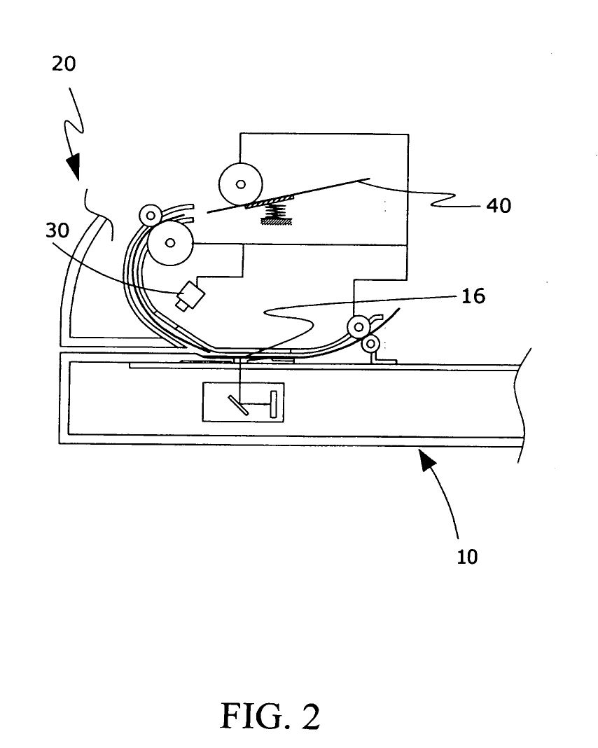

The position of the detector 30 is not limited to that in a paper tray of the automatic sheet feeder 20. For example, as shown in FIG. 2, the detector 30 may be mounted on a moving path of the sheet 40, and the detector 30 has to be positioned in front of a scanning position 16 of the scanner 10.

The detector 30 outputs the detecting signal 32 to the sheet in order to detect the thickness of the sheet 40. When the detecting signal 32 impinges on the sheet 40, the detecting signal 32 may pass through the sheet 40 or may be reflected by the sheet 40. In design, the thickness of the sheet may be determined according to the amplitude of the energy, the frequency, the delay time or the phase analysis of the signal.

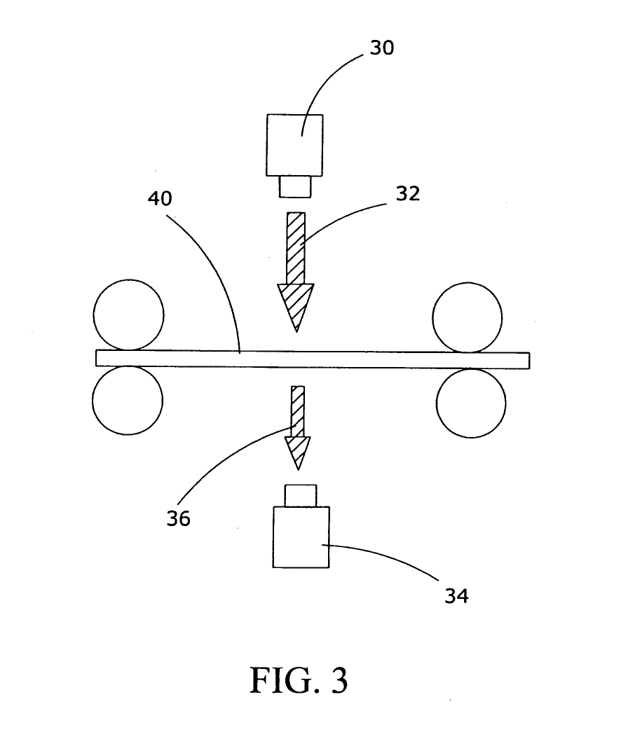

As shown in FIG. 3, if the detecting signal 32 of the detector 30 passes-through the sheet, another corresponding detector 34 should be disposed opposite to the detector 30 to receive the transmitted signal 36 passing through the sheet 40. The signal 36 received by the detector 34 indicates the residual energy after the detecting signal passes through the sheet 40, or the energy absorbed by the sheet 40. The signal 36 received by the detector 34 may serve as a reference for determining a thickness of the sheet 40.

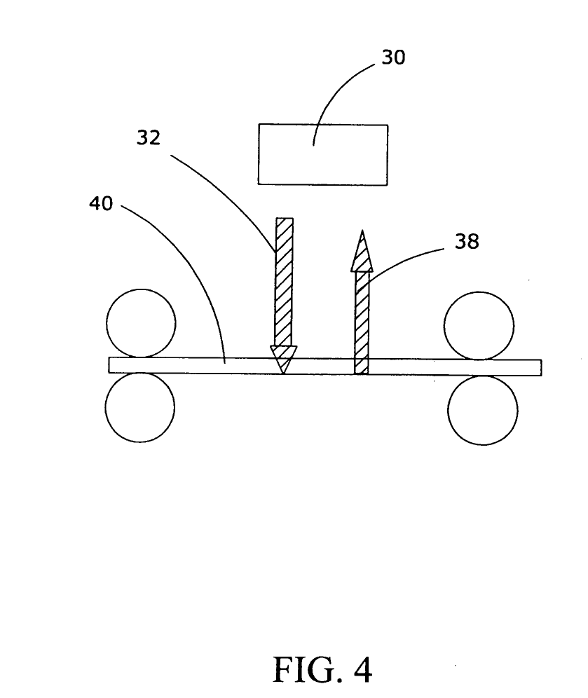

For example, assume the sheet having a basis weight of 70 to 100 grams per square meter (GSM) has a basic thickness. The detector 34 can obtain the signal having the residual energy A after the detecting signal 32 passes through the sheet having the basis weight of 70 GSM; and the detector 34 may obtain the signal 36 having the residual energy B after the detecting signal 32 passes through the sheet having the basis weight of 100 GSM. When the detector 34 obtains the signal 36 having the residual energy C after the detecting signal 32 passes through a sheet and B≦C≦A, the scanning device may determine that the sheet has a thickness equal to the basic thickness. If C>A, the scanning device may determine that the sheet 40 is thinner than the basic thickness. If C<B, the scanning device may determine that the sheet 40 is thicker than the basic thickness. As shown in the example illustrated in FIG. 4, the detecting signal 32 is a reflective signal, such as ultrasonic waves. When the detecting signal 32 impinges on the sheet 40, the detecting signal 32 is reflected by the sheet 40. Thus, the thickness of the sheet 40 may be determined according to the time/path difference between the detecting signal 32 outputted from the detector 30 and the reflected signal 38 received by the detector 30. For example, compared to the detecting signal 32, the signal 38 reflected by the sheet having the basic thickness of 70 GSM produces a time difference T1, and the signal 38 reflected by the sheet having the basic thickness of 100 GSM produces a time difference T2, wherein T1<T2. If the detecting signal 32 reflected by the sheet 40 produces a time difference T3 smaller than the time difference T1, the sheet 40 may be judged as thinner than the basic thickness. Also, if the signal 38 reflected by the sheet 40 produces a time difference T4 larger than the time difference T2, the sheet 40 may be judged as thicker than the basic thickness.

The above-mentioned ultrasonic transceiver or infrared transceiver used in this invention is available currently.

As shown in FIG. 1, when the sheet 40 is thick, the driving mechanism/power of the sheet-input roller 22 and the driving mechanism of the roller sets 26 and 27 are controlled so that the sheet 40 may be moved in the passageway 28 at a lower speed or with a larger torque.

When the sheet 40 is thin, the driving mechanism/power of the sheet-input roller 22 and the driving mechanism of the roller sets 26 and 27 are controlled so that the sheet 40 may be moved in the passageway 28 at a high speed or with a smaller torque.

The switch between different speeds or various torque outputs may be achieved by controlling the power source of the automatic sheet feeder. After the thickness of the sheet 40 is judged, the scanning speed can be adjusted by the user, or the scanning device can automatically adjust the scanning speed. If the user wants to adjust the scanning speed, a scanning speed switching mechanism may be disposed on the scanning device so that the speed or torque outputs may be adjusted and the object of adjusting the scanning speed can be achieved. The scanning device can automatically adjust the scanning speed by way of hardware control or software control.

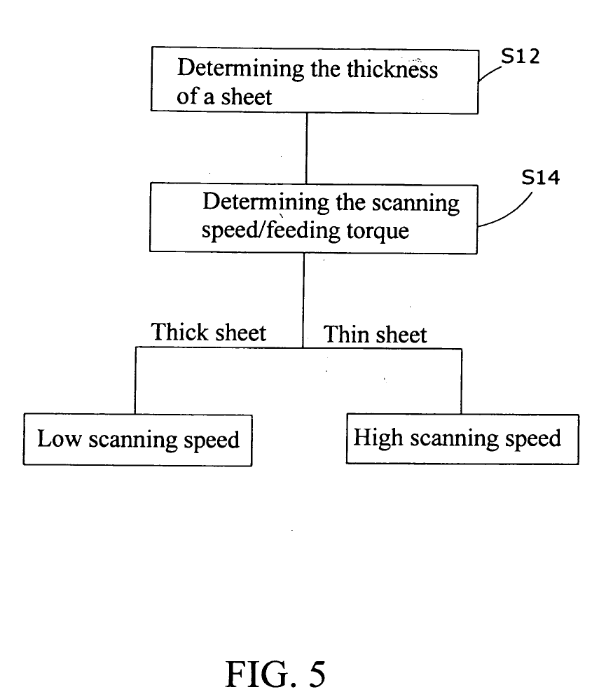

Referring to FIG. 5, the scanning method of the scanning device includes the following steps.

S12 is a step of determining the thickness of a sheet placed in the paper tray, or the thickness of the sheet before the sheet reaches the scanning position. In this step, the ultrasonic or infrared transceiver may emit the detecting signal to the sheet and receives the detecting signal reflected by the sheet or transmitted through the sheet. The reflected or transmitted signal may serve as the reference for automatically determining the thickness of the sheet, where the reflected or transmitted signal may be converted into a comparable parameter, such as the wavelength, time or the like. Then, the parameter is compared with other known parameters or constants, so that the thickness of the sheet may be determined.

S14 is a step of determining the scanning speed/feeding torque. The scanning speed/feeding torque is determined according to the thickness of the sheet. When the sheet is thick, the scanning device scans the sheet at a low scanning speed, that is, transporting the sheet at a low speed or with a larger feeding torque. When the sheet is thin, the scanning device scans the sheet at a high scanning speed, that is, transporting the sheet at a high speed or with a smaller feeding torque.

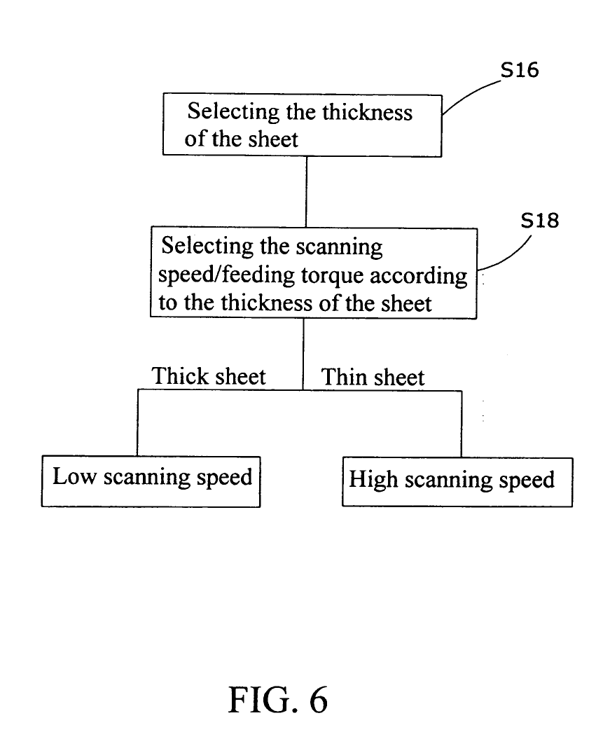

In this invention, the user may define the thickness of the sheet by himself or herself. In other words, the user may judge the thickness of the sheet according to the experience or the basis weight of the sheet. Thus, the detector in the scanning device of the invention can be removed. In this case, the scanning method of the scanning device includes the following steps, as shown in FIG. 6.

S16 is a step of selecting the thickness of the sheet. The user selects whether the sheet pertains to a thick sheet or a thin sheet according to the experience of the basis weight of the sheet.

S18 is a step of selecting the scanning speed/feeding torque according to the thickness of the sheet. A selection key may be disposed on the scanning device, or the selection function may be provided by the scan software. When the sheet is thick, the scanning device scans the sheet at a low scanning speed or transports the sheet with a larger feeding torque. When the sheet is thin, the scanning device scans the sheet at a high scanning speed or transports the sheet with a smaller feeding torque.

The scanning speed of the scanning device according to the invention may also be determined according to the image resolution and the thickness of the sheet.

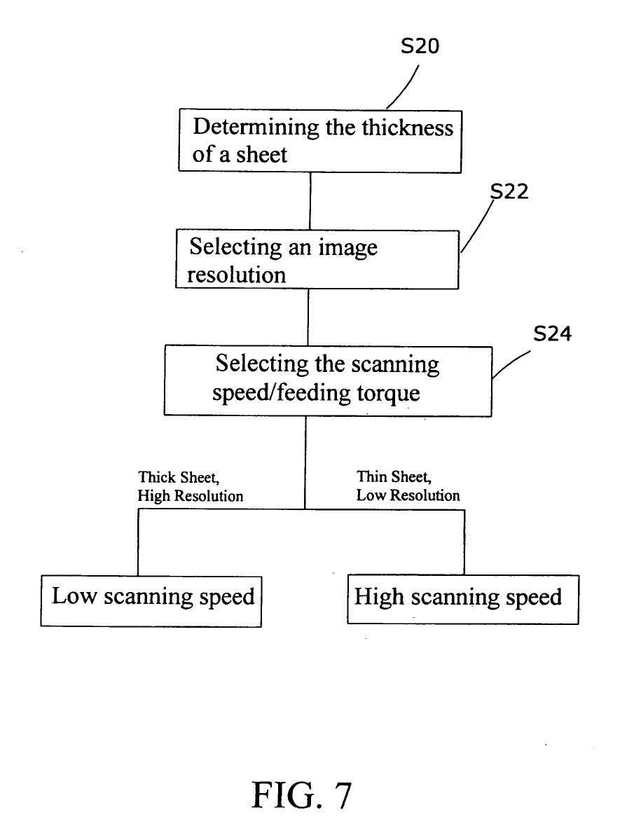

Referring to FIG. 7, the scanning method of the invention includes the following steps.

S20 is a step of determining the thickness of a sheet which is to be scanned by the scanning device. In this step, the reflective or transmissive detector may emit the detecting signal to the sheet, and the thickness of the sheet may be determined according to the transmitted or reflected signal received by the reflective or transmissive transceiver.

S22 is a step of selecting an image resolution by the application software of the scanning device.

S24 is a step of selecting the scanning speed/feeding torque according to the thickness of the sheet. When the sheet is thick and the image resolution is high, the scanning device scans the sheet at a low scanning speed. When the sheet is thin and the image resolution is low, the scanning device scans the sheet at a high scanning speed.

The scanning speed for a thin sheet at a low resolution and that for a thick sheet at a high resolution may be the same or different. However, the scanning speeds corresponding to the above-mentioned two conditions should falls within the range limited by the highest scanning speed the lowest scanning speed.

According to the scanning device and the scanning method mentioned hereinabove, the quality of the images generated can be obviously maintained because the thickness of the sheet and the image resolution are taken into consideration for adjusting the scanning speed of the scanning device.

Also, the detectors of the invention are disposed corresponding to the position or the moving path of the sheet and can facilitate the automatic detection of the thickness of the sheet and the controlling of the moving speed of the sheet. Further, the thickness of the sheet can be rapidly detected in a simplified design.

While the preferred embodiments of the present invention has been shown and described, it will be apparent to those skilled in the art that various modifications may be made in the embodiments without departing from the spirit of the present invention. Such modifications are all within the scope of the present invention.

What is claimed is:

1. A scanning method being applied to an image scanning device having an automatic sheet feeding function, the method comprising the steps of:
determining a thickness of a sheet before the sheet is scanned; and
determining a scanning speed according to the thickness of the sheet, wherein the scanning speed is inversely proportional to the thickness.

2. The method according to claim 1, wherein the thickness is determined according to a basis weight of the sheet.

3. The method according to claim 1, wherein in the step of determining the thickness of the sheet, a reflective signal transceiver emits a detecting signal to the sheet and receives the detecting signal reflected by the sheet, wherein the reflected detecting signal serves as a reference for automatically determining the thickness of the sheet.

4. The method according to claim 1, wherein in the step of determining the thickness of the sheet, a transmissive signal transceiver emits a detecting signal to the sheet and receives the detecting signal transmitted through the sheet, wherein the transmitted detecting signal serves as a reference for automatically determining the thickness of the sheet.

5. The method according to claim 1, wherein the scanning speed is directly proportional to a sheet feeding speed.

6. The method according to claim 1, wherein the scanning speed is inversely proportional to torque produced for feeding the sheet.

7. The method according to claim 1, further comprising the step of:
determining the scanning speed according to the thickness of the sheet and an image resolution.

8. The method according to claim 1, wherein the thickness of the sheet is determined when the sheet is placed in a paper tray.

9. The method according to claim 1, wherein the thickness of the sheet is determined before the sheet reaches a scanning position.

10. An image scanning device having an automatic sheet feeding function, the device comprising:
a body, in which a scanning module for scanning a sheet is disposed;
a sheet-feeding mechanism, connected with the body, for feeding the sheet; and
a detector disposed in the sheet-feeding mechanism, for detecting a thickness of the sheet before the sheet is scanned, wherein a sheet feeding speed of the sheet-feeding mechanism is determined according to the thickness of the sheet.

11. The device according to claim 10, wherein the body is a flatbed scanner and the sheet-feeding mechanism is an automatic sheet feeder.

12. The device according to claim 10, wherein the body is combined with the sheet-feeding mechanism to form a sheet-fed scanner.

13. The device according to claim 10, wherein the body is combined with the sheet-feeding mechanism to form a multi-function peripheral.

14. The device according to claim 10, wherein the detector is a reflective signal transceiver.

15. The device according to claim 14, wherein the reflective signal transceiver emits and receives ultrasonic waves.

16. The device according to claim 10, wherein the detector is a transmissive signal transceiver.

17. The device according to claim 16, wherein the transmissive signal transceiver emits and receives infrared light.
